(19) United States
(12) Patent Application Publication
(10) Pub. No.: US 2026/0178294 A1
(43) Pub. Date: Jun. 25, 2026

(54) METHODS OF AUTOMATICALLY ANALYZING BINARY CODE AND RELATED COMPUTING SYSTEMS AND COMPUTER-READABLE MEDIA

(71) Applicant: BATTELLE ENERGY ALLIANCE, LLC, Idaho Falls, ID (US)

(72) Inventors: Jedediah T. Haile, Idaho Falls, ID (US); Rita A. Foster, Idaho Falls, ID (US); Shaya Paige Marie Wolf, Idaho Falls, ID (US); Michael Cutshaw, Idaho Falls, ID (US); Bryan R. Beckman, Idaho Falls, ID (US); May Chaffin, Idaho Falls, ID (US)

(21) Appl. No.: 19/425,611

(22) Filed: Dec. 18, 2025

Related U.S. Application Data
(60) Provisional application No. 63/738,446, filed on Dec. 23, 2024.

(51) Int. Cl. G06F 8/41; G06N 3/0464; G06N 3/0895

(52) U.S. Cl. CPC G06F 8/427; G06N 3/0464; G06N 3/0895

(57) ABSTRACT

Methods of automatically analyzing binary code and related computing systems and computer-readable media are disclosed. A method includes processing the binary code to generate an abstract syntax tree (AST), a control flow graph (CFG), and a data flow graph (DFG) representing an algorithmic structure of the binary code. The method also includes encoding the AST, the CFG, and the DFG using graph convolutional neural networks to obtain a AST encodings, CFG encodings, and DFG encodings. The method further includes performing self-supervised contrastive learning on the AST encodings, the CFG encodings, and the DFG encodings to generate a set of aligned embeddings representing the algorithmic structure of the binary code across the AST, the CFG, and the DFG. A computing system includes a processor and a data storage device having computer-readable instructions stored thereon. The computer-readable instructions are configured to instruct the processors to perform the method.

### CROSS-REFERENCE TO RELATED APPLICATION

This application claims the benefit of under 35 U.S.C. § 119 of the earlier filing date of U.S. Provisional Application Ser. No. 63/738,446 filed Dec. 23, 2024, the entire disclosure of which is hereby incorporated herein by reference for any purpose.

### STATEMENT REGARDING FEDERALLY SPONSORED RESEARCH OR DEVELOPMENT

This invention was made with government support under Contract Number DE-AC07-05-ID14517 awarded by the United States Department of Energy. The government has certain rights in the invention.

### TECHNICAL FIELD

This disclosure relates generally to performing self-supervised contrastive machine learning on multiple embeddings for multiple different mathematical (e.g., graphical) representations of binary code and related methods, computing systems, and computer-readable media (e.g., non-transitory computer-readable media).

### BACKGROUND

Reverse engineering computer code is useful to enable a human to understand the algorithmic structure of a software or firmware program represented in binary code. Binary code includes sequences of ones and zeros to represent commands, memory addresses, and data for executing a software or firmware program. While binary code may be understandable and directly executed by a computer processor, binary code may be difficult for a human, even an experienced reverse engineer, to understand. A reverse engineer may be a person that reverses code from binary to higher and higher levels of human-readable code or at least code readable to a software programmer/software developer. Reverse engineering binary code may include conversion of binary code to a form that is more easily understood by a human.

### BRIEF SUMMARY

In some embodiments, a computing system includes one or more processors and one or more data storage devices having computer-readable instructions stored thereon. The computer-readable instructions are configured to instruct the one or more processors to process binary code to generate an abstract syntax tree (AST), a control flow graph (CFG), and a data flow graph (DFG) representing an algorithmic structure of the binary code. The computer-readable instructions are also configured to instruct the one or more processors to encode the AST, the CFG, and the DFG using graph convolutional neural networks to obtain AST encodings, CFG encodings, and DFG encodings, and perform self-supervised contrastive learning on the AST encodings, the CFG encodings, and the DFG encodings to generate a set of aligned embeddings representing the algorithmic structure of the binary code across the AST, the CFG, and the DFG.

In some embodiments, a method of automatically analyzing binary code includes processing the binary code to generate an AST, a CFG, and a DFG representing an algorithmic structure of the binary code. The method also includes encoding the AST, the CFG, and the DFG using graph convolutional neural networks to obtain AST encodings, CFG encodings, and DFG encodings. The method further comprises performing self-supervised contrastive learning on the AST encodings, the CFG encodings, and the DFG encodings to generate a set of aligned embeddings representing the algorithmic structure of the binary code across the AST, the CFG, and the DFG.

In some embodiments, one or more non-transitory computer-readable media has computer-readable instructions stored thereon, the computer-readable instructions configured to instruct one or more processors to process binary code to generate an AST, a CFG, and a DFG representing an algorithmic structure of the binary code. The computer-readable instructions are also configured to instruct the one or more processors to encode the AST, the CFG, and the DFG using graph convolutional neural networks to obtain AST encodings, CFG encodings, and DFG encodings, and perform self-supervised contrastive learning on the AST encodings, the CFG encodings, and the DFG encodings to generate a set of aligned embeddings representing the algorithmic structure of the binary code across the AST, the CFG, and the DFG.

In some embodiments, one or more non-transitory computer-readable media have computer-readable instructions stored thereon. The computer-readable instructions are configured to instruct the one or more processors to: process binary code to generate a first mathematical representation of the binary code, a second mathematical representation of the binary code, and a third mathematical representation of the binary code representing an algorithmic structure of the binary code; encode the first mathematical representation, the second mathematical representation, and the third mathematical representation to obtain first encodings corresponding to the first mathematical representation, second encodings corresponding to the second mathematical representation, and third encodings corresponding to the third mathematical representation; and perform self-supervised contrastive learning on the first encodings, the second encodings, and the third encodings to generate a set of aligned embeddings representing the algorithmic structure of the binary code across the first mathematical representation, the second mathematical representation, and the third mathematical representation.

### BRIEF DESCRIPTION OF THE DRAWINGS

While this disclosure concludes with claims particularly pointing out and distinctly claiming specific embodiments, various features and advantages of embodiments within the scope of this disclosure may be more readily ascertained from the following description when read in conjunction with the accompanying drawings, in which:

FIG. 1 is a flowchart illustrating a method of automatically analyzing a binary code, according to some embodiments;

FIG. 2 is a block diagram of an example of an algorithmic structure that may be used to implement the method of FIG. 1;

FIG. 3 is a block diagram of an example of a computing system that may be used to implement the method of FIG. 1;

FIG. 4 is a block diagram of an example of an AST to CFG self-supervised contrastive learning;

FIG. 5 is a block diagram of a self-supervised contrastive learning algorithm, which is an example of self-supervised contrastive learning of FIG. 2;

FIG. 6 is a flowchart illustrating a method of automatically analyzing binary code, according to some embodiments; and

FIG. 7 is a block diagram of circuitry that, in some embodiments, may be used to implement various functions, operations, acts, processes, and/or methods disclosed herein.

### DETAILED DESCRIPTION

In the following detailed description, reference is made to the accompanying drawings, which form a part hereof, and in which are shown, by way of illustration, specific examples of embodiments in which the present disclosure may be practiced. These embodiments are described in sufficient detail to enable a person of ordinary skill in the art to practice the present disclosure. However, other embodiments enabled herein may be utilized, and structural, material, and process changes may be made without departing from the scope of the disclosure.

The illustrations presented herein are not meant to be actual views of any particular method, system, device, or structure, but are merely idealized representations that are employed to describe the embodiments of the present disclosure. In some instances, similar structures or components in the various drawings may retain the same or similar numbering for the convenience of the reader; however, the similarity in numbering does not necessarily mean that the structures or components are identical in size, composition, configuration, or any other property.

The following description may include examples to help enable one of ordinary skill in the art to practice the disclosed embodiments. The use of the terms “exemplary,” “by example,” and “for example,” means that the related description is explanatory, and though the scope of the disclosure is intended to encompass the examples and legal equivalents, the use of such terms is not intended to limit the scope of an embodiment or this disclosure to the specified components, steps, features, functions, or the like.

It will be readily understood that the components of the embodiments as generally described herein and illustrated in the drawings could be arranged and designed in a wide variety of different configurations. Thus, the following description of various embodiments is not intended to limit the scope of the present disclosure, but is merely representative of various embodiments. While the various aspects of the embodiments may be presented in the drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art will understand that information and signals may be represented using any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the embodiments disclosed herein may be implemented or performed with a general purpose processor, a special purpose processor, a digital signal processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is configured to execute computing instructions (e.g., software code) related to embodiments of the present disclosure.

The embodiments may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, other structure, or combinations thereof. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may include one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

As used herein, the term “binary code” refers to a low-level representation of computer-readable instructions and data that a computer processor may directly execute. Binary code includes sequences of bits, usually represented as ones and zeros. These sequences of bits represent commands, memory addresses, and data that are used in executing a software or firmware program or algorithm. In some examples, binary code may be stored in one or more binary files. Accordingly, the term “binary file,” as used herein, refers to an executable file that stores binary code that may be directly executed by a processor. Software and firmware programs are usually created using higher level programming languages that are understandable to humans (e.g., to reverse engineers and/or software developers). Examples of higher level programming languages include ANSI C, Java, Python, C++, and many other diverse forms of programming languages. Computer code written in higher level programming languages may be compiled into an executable file (i.e., a binary file) in a form (binary code) that may be directly read and executed by a computer processor. Likewise, decompiler software programs may be used to take binary code and reverse it to various levels of intermediate languages. The lower the level, the closer the decompiled code is to assembly code and the higher the level, the closer the decompiled code is to programming languages used by human software developers to develop software code.

Decompiling binary code may be useful to enable identification and understanding of malware. For example, binary files received by a computing device via email and internet communications may be decompiled to determine whether they pose a threat to the computing system. A malware filter may be equipped with automatic decompiling capabilities to enable identification and removal of binary code that poses a threat from internet and email communications. Also, identified malware may be analyzed using decompiling to understand how the malware attacks the victim computer system.

Decompiling binary code may also be useful to analyze quality of software or firmware code in software or firmware development. For example, modern software and firmware development increasingly rely on artificial intelligence to generate computer code. Although a piece of computer code generated by artificial intelligence may perform the operations it is designed to perform, this computer code may not always be of high quality. For example, computer code generated by artificial intelligence may be vulnerable to cyber-attack in ways not known to the developers that use the computer code in their software or firmware development. As another example, the computer code may perform operations that are not necessary for overall operation, rendering the computer code less efficient than it may be. Accordingly, in software or firmware development, binary code may be decompiled to enable a human to understand the algorithmic structure, which may provide an opportunity to remove vulnerabilities built into computer code and/or improve the efficiency of the computer code. Furthermore, decompiling binary code may be used to detect low-quality code and identify artificial intelligence-generated code.

Many energy systems and other critical infrastructure have software and/or firmware vulnerabilities. Detecting these vulnerabilities may be challenging. Software and firmware vulnerability defenders are often unaware of all the software or firmware components present in each system or how hackers using malware could be exploiting them. Machine learning techniques may be used to reverse engineer binary code to identify vulnerabilities in software or firmware, and to flag changes that might indicate the presence of malware. Some embodiments disclosed herein may enable reverse engineers and/or software developers to capture, preserve, and share information from their analyses, overcoming the problem of siloed and missing knowledge about software or firmware binaries in existing systems (e.g., energy systems). Visualization tools disclosed herein may assist in depicting how binaries interact with one another, which may simplify the analysis process. These tools may assist software developers in code quality analysis to ensure new vulnerabilities are not being introduced to systems, as well as supply chain analysis to determine what binaries are present in a system.

Examples of visualization tools that may be used in embodiments disclosed herein may include abstract syntax trees (ASTs), control flow graphs (CFGs), and data flow graphs (DFGs). ASTs are tree-structured representations of syntax structure of source code in programming. An AST may include nodes representing constructs such as expressions, operators, statements, and control structures (e.g., for and while loops, conditional clauses such as if-then clauses). CFGs are graphical representations of possible paths that a computer program may traverse while executing a particular binary code. CFGs include nodes that represent basic blocks, which are straight-line sequences of code with no jumps or branches other than at entry and exit points. CFGs also include edges that represent possible flows of control from one block to another. DFGs are graphical representations of flow of data through a computer program. DFGs may illustrate how data values are produced, transformed, and consumed through different operations. DFGs may emphasize relationships and dependencies between data and values. DFGs include nodes that represent operations (e.g., arithmetic calculations, function calls, or other data transformations) or data variables. DFGs also include edges that represent data dependencies between nodes, showing the flow of data from one operation or variable to another.

Various embodiments disclosed herein may generate a well-curated language model from automatically reverse engineered binaries with cohesive triple embeddings. Additional machine learning and statistical analysis may be used to understand and identify facets of firmware/software. Embodiments disclosed herein may seek to identify relationships between nodes of computer code (e.g., including one or more functions). This focus on relationships between nodes of computer code may enable data to be viewed in context. This resulting ability to view data in context is a technical improvement over systems that focus on nodes of computer code rather than on the relationships between nodes of computer code because focusing on the nodes of computer code does not enable the viewing of data in context.

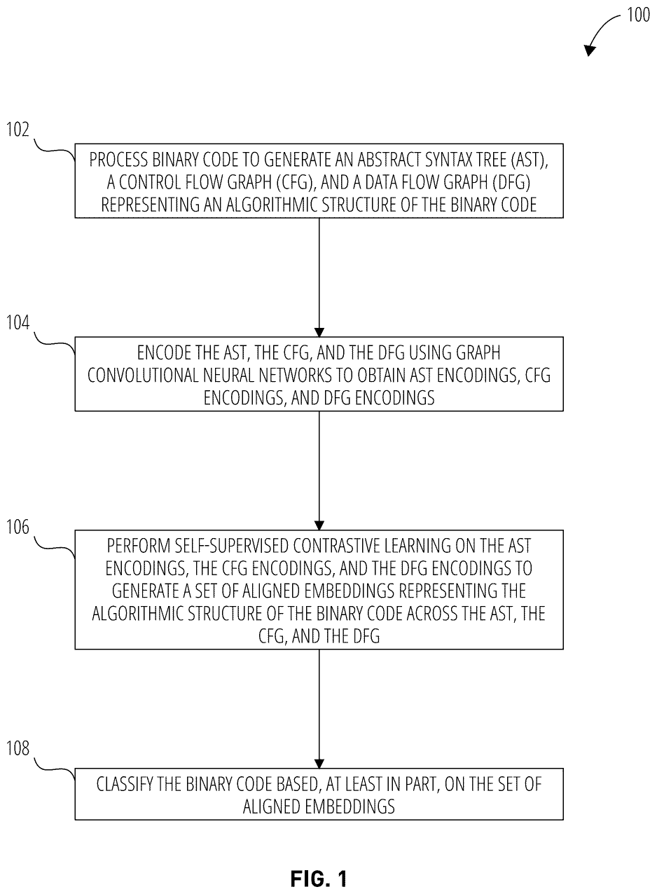

FIG. 1 is a flowchart illustrating a method 100 of automatically analyzing binary code, according to some embodiments.

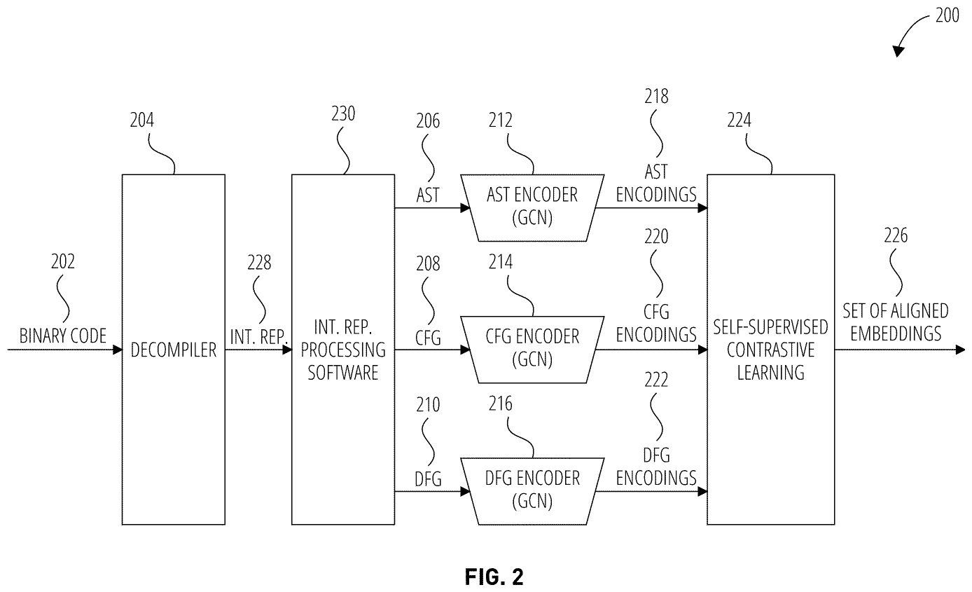

FIG. 2 is a block diagram of an example of an algorithmic structure 200 that may be used to implement the method 100 of FIG. 1. FIG. 2 illustrates binary code 202, which may be included in a binary file, in some instances. In some embodiments, the binary code 202 may be code generated using artificial intelligence. In some embodiments, the binary code 202 includes malware binary code. Since binary code is difficult for a human to understand, it may be desirable to perform the method 100 on the binary code 202 to make the binary code 202 understandable to a human.

The algorithmic structure 200 includes a decompiler 204 configured to reverse engineer the binary code 202 and produce an intermediate representation 228 of the binary code 202. The algorithmic structure 200 also includes intermediate representation processing software 230 configured to generate graphical visualizations (e.g., an AST 206, a CFG 208, a DFG 210, etc.) of the binary code 202 based, at least in part, on the intermediate representation 228. The algorithmic structure 200 also includes graph convolutional neural networks including an AST encoder 212, a CFG encoder 214, and a DFG encoder 216. The algorithmic structure 200 further includes self-supervised contrastive learning 224. In some embodiments, the binary code 202 may be binary code that has not been previously processed by the method 100 (FIG. 1). In some embodiments, the binary code 202 may be the same as or may be similar to a binary code that has already been previously processed by the method 100, in which case a saved database of information from the decompiler 204 may be used to save time disassembling/decompiling the binary code 202.

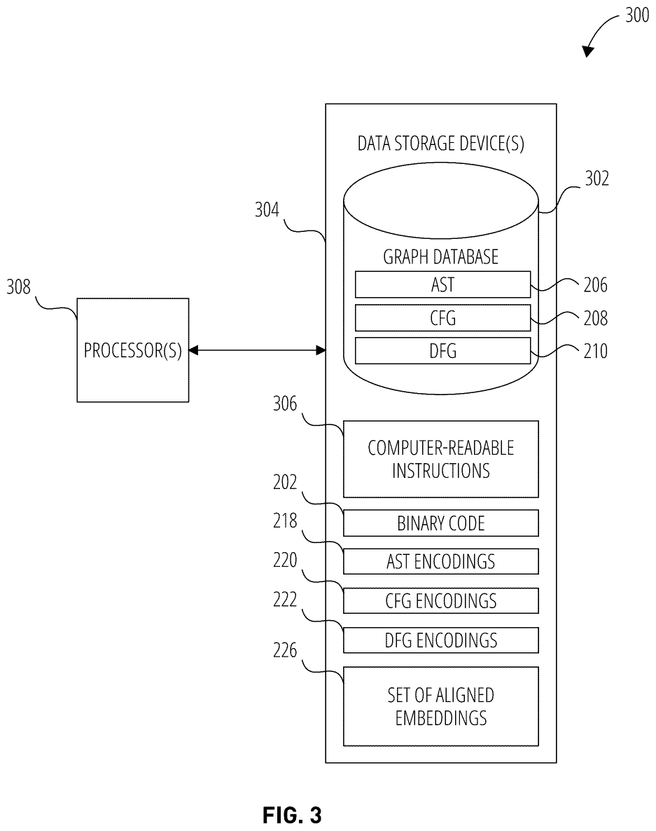

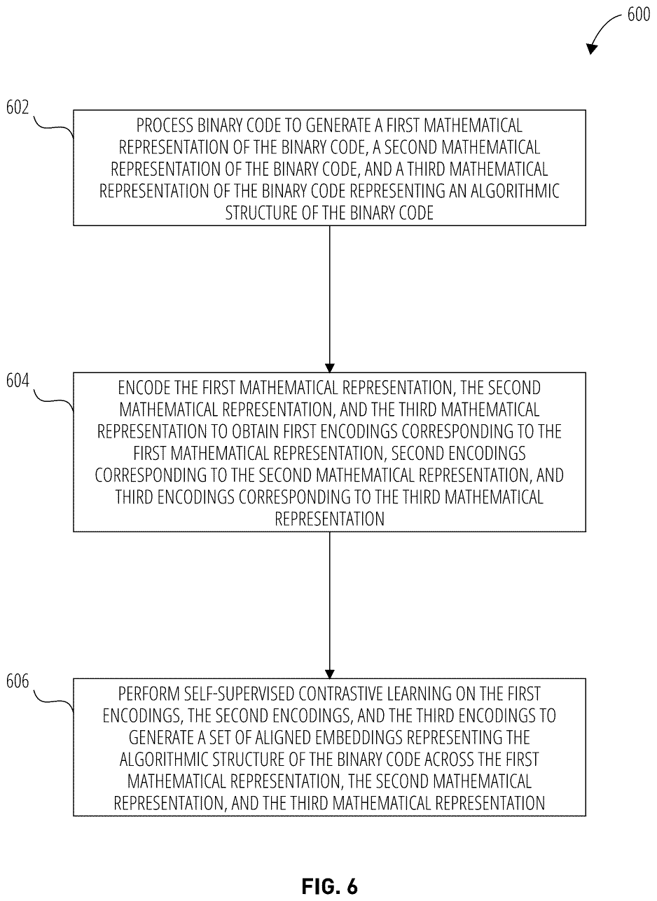

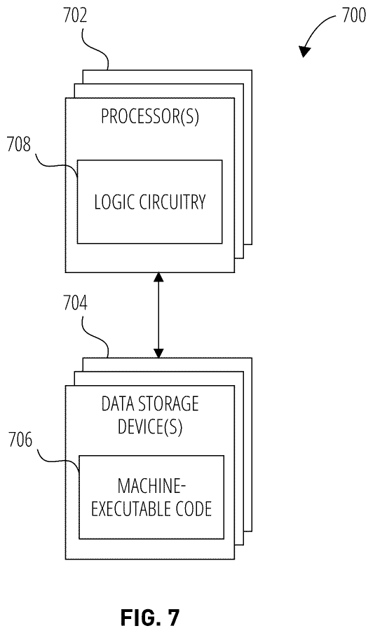

FIG. 3 is a block diagram of an example of a computing system 300 that may be used to implement the method 100 of FIG. 1. The computing system 300 includes one or more processors 308 (e.g., processors 702 of FIG. 7) operably coupled to one or more data storage devices 304 (e.g., storage 704 of FIG. 7). The one or more data storage devices 304 have the binary code 202 and computer-readable instructions 306 stored thereon. The computer-readable instructions 306 are configured to instruct the one or more processors 308 to perform operations of the method 100 (e.g., or method 600 of FIG. 6) and operational components of the algorithmic structure 200 (e.g., the decompiler 204, the intermediate representation processing software 230, the AST encoder 212, the CFG encoder 214, the DFG encoder 216, and the self-supervised contrastive learning 224), as will be discussed in more detail below.

Referring to FIG. 1, FIG. 2, and FIG. 3 together, at operation 102, the method 100 includes processing the binary code 202 to generate an abstract syntax tree (AST 206), a control flow graph (CFG 208), and a data flow graph (DFG 210) representing an algorithmic structure of the binary code 202. Processing the binary code 202 at operation 102 may include processing the binary code 202 with the decompiler 204 using any of a variety of different commercially available platforms, such as BINARYNINJA®, developed by Vector 35 Inc. of Melbourne, FL to provide an intermediate representation 228 of the binary code 202. Processing the binary code 202 at operation 102 may also include processing, using intermediate representation processing software 230, the intermediate representation 228 of the binary code 202 provided by the decompiler 204 to generate the AST 206, the CFG 208, and the DFG 210. Examples of commercially available intermediate representation processing software include decompiler integrated tools such as Ghidra (an open-source reverse engineering framework developed by the National Security Agency (NSA)) and Interactive Dissassembler Professional (IDA) Pro (developed by Hex-Rays of Liege, Belgium); program analysis frameworks such as Angr (developed by Seclab at University of California, Santa Barbara), Radare2 (an open-source framework developed by the Radare2 community), and BINARY NINJA®; intermediate representation tools such as LLVM (maintained by the LLVM Foundation of Beaverton, Oregon) and Binary Analysis Platform (BAP) (developed by Trail of Bits of New York City, New York); or custom scripts and/or plugins. The AST 206, the CFG 208, and the DFG 210 may be stored in a graph database 302 on the one or more data storage devices 304.

In embodiments, processing the binary code 202 (operation 102) may include processing an artificial intelligence generated binary code. Accordingly, the method 100 may be used to analyze a quality of code generated by artificial intelligence. In embodiments where the binary code 202 is malware binary code (e.g., received in an email message and/or over the Internet), processing the binary code 202 (operation 102) may include processing a malware binary code.

At operation 104, the method 100 includes encoding the AST 206, the CFG 208, and the DFG 210 using graph convolutional neural networks to obtain AST encodings 218, CFG encodings 220, and DFG encodings 222. For example, the AST encoder 212 may encode the AST encodings 218 to generate the AST encodings 218, the CFG encoder 214 may encode the CFG 208 to generate the CFG encodings 220, and the DFG encoder 216 may encode the DFG 210 to generate the DFG encodings 222. The AST encodings 218, the CFG encodings 220, and the DFG encodings 222 may be stored on the one or more data storage devices 304. In some embodiments, the AST encodings 218, the CFG encodings 220, and the DFG encodings 222 may be normalized (e.g., row normalized or some other form of normalization).

In some embodiments, a graph convolution neural network may be used by an AST encoder 212, a CFG encoder 214, and/or a DFG encoder 216 of the algorithmic structure 200 of FIG. 2. By way of non-limiting example, the graph convolution neural network may be implemented by the computer-readable instructions 306 of FIG. 3. By way of non-limiting example, the graph convolution neural network may includes a first convolution layer, a first pooling layer, a second convolution layer, a second pooling layer, a global pooling layer, and a dense layer. A GCN input applied to the graph convolution neural network may include one of the AST 206, the CFG 208, or the DFG 210 of FIG. 2 and FIG. 3. A GCN output generated at the dense layer responsive to the GCN input being provided to the first convolution layer may include the AST encodings 218, the CFG encodings 220, or the DFG encodings 222 of FIG. 2 and FIG. 3, depending on which of the AST 206, the CFG 208, or the DFG 210 was provided as the GCN input. The GCN output may include whole graph embeddings, corresponding to graph-level output to provide an understanding of an entire structure of the graphical representation input to the graph convolution neural network as the GCN input.

Where the graph convolution neural network is operating as the AST encoder 212 of FIG. 2, the GCN input may include a node features matrix and an adjacency list or adjacency matrix corresponding to the AST 206 of FIG. 2. By way of non-limiting example, the node features matrix for an AST 206 may include features identifying nodes in the AST 206 (e.g., each row representing a node and each column representing a feature of that node). Features of a node may include a node type (e.g., keywords, operators, literals, identifiers, etc.), token values, and/or position information. An adjacency list or adjacency matrix for an AST 206 may encode edges (e.g., connections) between the nodes in the node features matrix and may leverage such edge encodings in the convolution of the graph embedding rather than just the nodes alone. For the AST 206, the edges describe the syntactic structure of the code. The resulting GCN output may provide a graph-level output providing a comprehensive summary of the AST 206, encapsulating both the relationships and the semantics of the nodes.

Where the graph convolution neural network is operating as the CFG encoder 214 of FIG. 2, the GCN input may include a node features matrix and an adjacency list or adjacency matrix corresponding to the CFG 208 of FIG. 2. By way of non-limiting example, features of a node may include an instruction type, an opcode, operands, and/or block frequency or weight. An adjacency list or adjacency matrix for a CFG 208 may encode edges (e.g., connections) between the nodes in the node features matrix. By way of non-limiting example, the adjacency list or adjacency matrix may encode control flow structure by representing directed edges between nodes in the node features matrix. For the CFG 208, the edges describe how programmatic control is passed between nodes. The resulting GCN output may provide a graph-level output that gives insight as to meaningful patterns in control flow and node features.

Where the graph convolution neural network is operating as the DFG encoder 216 of FIG. 2, the GCN input may include a node features matrix and an adjacency list or adjacency matrix corresponding to the DFG 210 of FIG. 2. For the DFG 210, nodes may represent computations, operations, or variables, and edges may represent the flow of data between the nodes. By way of non-limiting example, the node features matrix for a DFG 210 may include features identifying nodes in the DFG 210 (e.g., each row representing a node and each column representing a feature of that node). Features of a node may include a node type (e.g., type of operation or variable), opcode, operands, data type, profiling information etc.). An adjacency list or adjacency matrix for a DFG 210 may encode edges (e.g., connections) between the nodes in the node features matrix. For DFG 210, the edges may represent how the data flows between nodes. The resulting GCN output may provide a graph-level output providing a comprehensive summary of the DFG 210, giving insight into the structure and data flow properties of the binary code 202.

Other network architectures (e.g., using a graph convolutional neural network) different from that discussed above may be used for the AST encoder 212, the CFG encoder 214, and/or the DFG encoder 216. Table 1 illustrates examples of possible components (e.g., layers and functions) that may be used by the AST encoder 212, the CFG encoder 214, and/or the DFG encoder 216.

TABLE 1
Examples of possible components (e.g., layers and functions)
that may be used to create embeddings

| Method | Description | Equation/Formula | Verification |
|---|---|---|---|
| Linear( ) | Linear affine | y = xA^{T} + b | Check dimensions of |
| | transformation, | | the input and output |
| | used to resize | | |
| | sample vector | | |
| | size | | |
| ReLU( ) | Rectified linear | ReLU(x) = max(0, x) | Check that there are no |
| | unit function for | | negative activations |
| | activation | | |
| Sigmoid( ) | Element-wise Sigmoid | $σ ( x ) = \frac{1}{1 + {e}^{- x}}$ | Check that all values fall between zero and |
| | activation | | one |
| | function | | |
| BatchNorm_1d | Batch normalization to enhance training | $y = \frac{x - E [ x ]}{\sqrt{Var [ x ] + ε}} * γ + β$ | Check that the batch has a mean of zero and a standard deviation of |
| | stability | | one |
| Dropout( ) | Regularization | Randomly (using a | Check the number of |
| | technique that | Bernoulli distribution) | zeroes in the input |
| | also prevents | zero out some | versus the output |
| | networks from | elements of the input | |
| | overlapping node | tensor | |
| | behavior | | |
| Global Add Pool( ) | Pooling method that acts on the node features on | ${s}_{i} = {\sum }_{n = 1}^{{N}_{i}} {x}_{i} , for$ graph i | Check the summation and ensure the output size is correct |
| | a batch-wise, | | |
| | graph-level basis | | |
| GINEConv( ) | Graph Isomorphism Network updated | ${x}_{i}^{′} = {h}_{θ} ( ( 1 + ϵ ) \cdot {x}_{i} + {\sum }_{j ∈ N ( i )} R e L U ( {x}_{j} + {e}_{j , i} ) )$ | Check the size of the network and complete statistical analyses on |
| | to handle edge | | the output, ensuring the |
| | features in the | | output falls within |
| | convolution | | expected ranges |
| | aggregation, then | | |
| | mapped by | | |
| | network h_θ | | |
| JumpingKnowledge( ) | Module that leverages node | $J K ( x ) = {\sum }_{t = 1}^{T} {α}_{v}^{( t )} {x}_{v}^{( t )} ,$ | |
| | neighborhoods for structure- | $with {α}_{v}^{( t )} attention$ | |
| | aware | | |
| | aggregation | | |

Other artificial intelligence networks may also be used for the AST encoder 212, the CFG encoder 214, and/or the DFG encoder 216. Examples of artificial intelligence networks that may be used are listed in Table 2.

TABLE 2
Examples of artificial intelligence networks that may be used for the
AST encoder 212, the CFG encoder 214, and/or the DFG encoder 216

| | | Model | | |
|---|---|---|---|---|
| Method | Description | Architecture | Verification | Components used |
| Edge | Create | Simple | Check the output via | Linear( ), ReLU( ), |
| Attribute | embedding | network | combinations of the | Sigmoid( ) |
| Network | for edge | including two | following: | |
| | attributes | transformation- | Complete a t- | |
| | | activation | SNE plot to | |
| | | pairs | visualize the | |
| Node Feature | Neural | Simple | edge | Linear( ), ReLU( ), |
| Neural | network | network | embeddings | BatchNorm_1d( ) |
| Network | constructed | including two | and ensure | |
| | to pass to | transformation- | similar edges | |
| | the | activation | map to the | |
| | GINEConv | pairs, followed | same space | |
| | module | by a batch | Complete a | |
| | | normalization | statistical | |
| GIN | Combination | Fully | analysis from | GINEConv( ), |
| Convolutional | of | constructed | the outputs | JumpingKnowledge( ), |
| Network | GINEConv | network | and ensure that | ReLU( ), Dropout( ), |
| | modules to | routing the | the distance | Linear( ) |
| | update the | node and edge | between node | |
| | nodes | embeddings | vectors is | |
| | vectors | through the | largest | |
| | based on the | GINEConv | between | |
| | edge | modules with | dissimilar | |
| | embeddings | a simple | nodes | |
| | | network at the | Complete a | |
| | | end | cross-validation | |
| Convolutional | Full graph | Combination | assessment | Linear( ), ReLU( ), |
| Graph | encoder that | of node and | Complete an | Dropout( ), |
| Encoder | takes a | edge | assessment | Global_Add_Pool( ), |
| | graph (AST, | embedding | across | Edge Attribute |
| | CFG, or | modules | different | Network, Node |
| | DFG) and | | hyperparameter | Feature Neural |
| | returns a | | selections | Network, GIN |
| | semantic | | Also complete the | Convolutional |
| | embedding | | following: | Network |
| Example | Contrastive | Combination | Randomly | Convolutional Graph |
| system | Self- | of three | split the | Encoder |
| | Supervised | Convolutional | training data | |
| | Graph | Graph | into three | |
| | Learning | Encoders (one | distinct sets, | |
| | model | per AST, CFG, | for training, | |
| | | and DFG), | testing, and | |
| | | shown in | validation | |
| | | FIG. 2. | Analyze the training | |
| | | | data to understand | |
| | | | statistically what to | |
| | | | expect from the | |
| | | | model | |

Referring once again to FIG. 1, FIG. 2, and FIG. 3 together, at operation 106, the method 100 includes performing self-supervised contrastive learning 224 on the AST encodings 218, the CFG encodings 220, and the DFG encodings 222 to generate a set of aligned embeddings 226 representing the algorithmic structure of the binary code 202 across the AST 206, the CFG 208, and the DFG 210. The set of aligned embeddings 226 may be stored on the one or more data storage devices 304. At operation 108, the method 100 includes classifying the binary code based, at least in part, on the set of aligned embeddings.

Since the self-supervised contrastive learning 224 processes three different types of embedded graphs (all representing the same algorithmic structure of the binary code 202), the set of aligned embeddings 226 output by the self-supervised contrastive learning 224 may include aligned graph embeddings. For each one of the AST encodings 218, the CFG encodings 220, and the DFG encodings 222, the self-supervised contrastive learning 224 generates vector embeddings for nodes, edges, or entire substructures. These embeddings capture features specific to each graph type and are aligned across the three embeddings to represent the shared underlying structure of the binary code 202. The set of aligned embeddings 226 may be robust and generalizable for downstream tasks such as node classification, link prediction, or clustering. Accordingly, due to training on three different embeddings, the self-supervised contrastive learning 224 creates embeddings (e.g., the set of aligned embeddings 226) that are more comprehensive and capture various aspects of the structure across different embeddings.

In some embodiments, an alignment of the set of aligned embeddings 226 includes more than three embeddings and is applicable to further collections of machine learning models. A multi-faceted/multi-channel contrastive learning algorithm leverages encoded information (e.g., the encoded AST, CFG, and/or the DFG) to represent the algorithmic structure of the binary code 202.

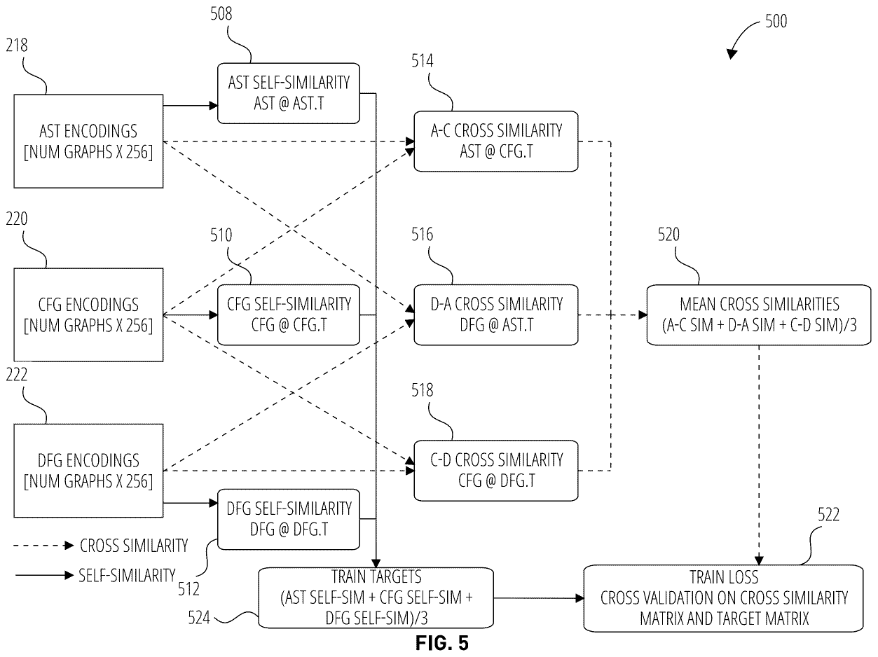

In the example illustrated in FIG. 2, three encodings are illustrated (e.g., the AST encodings 218, the CFG encodings 220, and the DFG encodings 222). More generically, any number of encodings, each representing a perspective of binary code that is to be represent mathematically, may be used as inputs to a self-supervised contrastive learning system (e.g., the self-supervised contrastive learning 224 of FIG. 2, the self-supervised contrastive learning system 500 of FIG. 5). The alignment of those inputs may be such that each encoding/embedding mechanism used to generate the individual perspectives is trained to generate the same answer, such that an individual mechanism trained to understand the code in one way uses the same mathematical layout to describe all code. Cohesive, multi-faceted embeddings of a piece of decompiled code may be output.

These encodings/embeddings may each be built using machine learning models that learn to generate a representation of the code using encodings of the specified features/aspects pertinent to that representation. Using the DFG encodings (e.g., the DFG encodings 222 of FIG. 2) as a non-limiting example, a model that learns to represent data passing through different instructions may be created to characterize how data passes around throughout the code. In some embodiments, a graph convolutional network may be used. In some embodiments, other algorithms may be used. For example, some graphs benefit from additional layers in the model beyond the graph convolution. A particular model may represent any of a variety of different perspectives.

A model that creates an embedding creates a mathematical field where every piece of code may be mapped to a location in that field such that related items are grouped together. A model trained to understand one perspective, however, may not pick the same mathematical field as a model trained to understand a different perspective. The learning algorithm trains the overall collection of machine learning models, causing them to each embed their representations in their respective mathematical fields in such a way that it is accurate for their perspective, but also such that their mathematical fields match all the other perspectives' mathematical fields. In this way, the various embeddings (e.g., multi-faceted embeddings) are aligned.

In some embodiments, more than two embeddings are aligned (e.g., in the example of FIG. 2, three embeddings are aligned). In some embodiments, more than three embeddings (e.g., up to five or more embeddings) are aligned.

In the example illustrated in FIG. 2, an AST 206, a CFG 208, and a DFG 210 are used to represent the binary code 202. More generically, any number of encodings/embeddings generated from any form of mathematical representation of the binary code 202 (e.g., including ASTs, CFGs, DFGs, and other forms of representing the binary code 202 including, for example, a program dependence graph (PDG), a system dependence graph (SDG), a call graph, a control dependence graph, a value flow graph, a static single assignment (SSA) form, an abstract interpretation lattice, a petri net, a control/data flow matrix, or a hypergraph) may be aligned (e.g., using graph convolutional networks or other models).

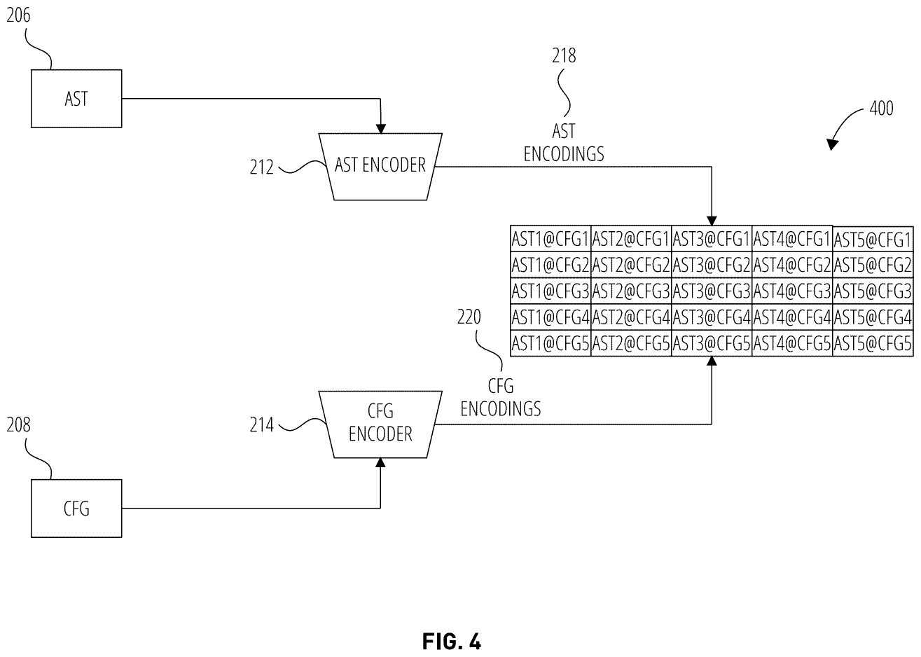

FIG. 4 is a block diagram of an example of an AST to CFG self-supervised contrastive learning 400. FIG. 4 illustrates the AST 206, the CFG 208, the AST encoder 212, and the CFG encoder 214 of FIG. 2. As illustrated in FIG. 4, the AST 206 is applied to the AST encoder 212 to generate the AST encodings 218 and the CFG 208 is applied to the CFG encoder 214 to generate the CFG encodings 220.

Each vertex in the AST 206 may include a feature vector created by using, for example, a language model on the original code fragment (e.g., binary code 202 of FIG. 2). The feature vector may be created using other embeddings other than a language model in some embodiments. Each vertex in the CFG 208 has a language model vector representing the block. A node may include five functions, a first function corresponding to AST1 and CFG1, a second function corresponding to AST2 and CFG2, a third function corresponding to AST3 and CFG3, a fourth function corresponding to AST4 and CFG4, and a fifth function corresponding to AST5 and CFG5.

By way of non-limiting example, the AST to CFG self-supervised contrastive learning 400 portion of the self-supervised contrastive learning 224 may include determining a cross similarity between each of the vertices of the AST encodings 218 and each of the vertices of the CFG encodings 220. In some embodiments, the cross similarity between a vertex of the AST encodings 218 and a vertex of the CFG encodings 220 may be determined as an inner dot product between the vertices. The AST to CFG self-supervised contrastive learning 400 shows inner dot products (shown as “@” in FIG. 4) between five different AST vertices (AST1, AST2, AST3, AST4, and AST5) and five different CFG vertices (CFG1, CFG2, CFG3, CFG4, and CFG5). Since the elements of the matrix on the top left to bottom right diagonal correspond to the same function, the AST to CFG self-supervised contrastive learning 400 may be trained to minimize the elements in the diagonal of the matrix shown in FIG. 4 for the AST to CFG self-supervised contrastive learning 400 and to maximize other elements of the matrix. The AST to CFG self-supervised contrastive learning 400 may be a many-to-many computation across all dimensions of the AST encodings 218 and the CFG encodings 220.

Similar self-supervised contrastive learning operations as those shown between the AST 206 and the CFG 208 in FIG. 4 (the AST to CFG self-supervised contrastive learning 400) may be performed between the AST 206 and the DFG 210 (e.g., the D-A cross similarity 516 of FIG. 5) and between the CFG 208 and the DFG 210 (e.g., the C-D cross similarity 518 of FIG. 5), as will be discussed with reference to FIG. 5.

FIG. 5 is a block diagram of a self-supervised contrastive learning system 500, which is an example of the self-supervised contrastive learning 224 of FIG. 2. Since the self-supervised contrastive learning system 500 is self-supervised and contrastive, the self-supervised contrastive learning system 500 aligns the representations across all three graph types (e.g., the AST encodings 218, the CFG encodings 220, and the DFG encodings 222 of FIG. 2). Accordingly, embeddings for corresponding elements across the graphs (positive triplets) are optimized to be similar, while embeddings for non-corresponding elements (negative triplets) are differentiated. This alignment is intended to ensure that the self-supervised contrastive learning system 500 produces consistent representations of the same structure, regardless of the graph type.

The self-supervised contrastive learning system 500 includes a self-similarity determination for the AST encodings 218, the CFG encodings 220, and the DFG encodings 222, which may be of a size that is the number of graphs times the number of graphs (num graphs×num graphs) (e.g., num graphs×256). For example, the self-supervised contrastive learning system 500 includes an AST self-similarity 508, a CFG self-similarity 510, and a DFG self-similarity 512. The self-similarity determination for the AST encodings 218, the CFG encodings 220, and the DFG encodings 222 is determined to be an inner dot product (expressed as “@” in FIG. 5) of an encoding matrix and a transpose of the encoding matrix for each of the AST encodings 218 (AST @ AST.T, where AST is the encoding matrix and AST T is a transpose of the encoding matrix), the CFG encodings 220 (CFG @ CFG.T, where CFG is the encoding matrix and CFG.T is a transpose of the encoding matrix), and the DFG encodings 222 (DFG @ DFG.T, where DFG is the encoding matrix and DFG.T is a transpose of the encoding matrix).

The self-supervised contrastive learning system 500 also includes cross similarity determinations between the AST encodings 218, the CFG encodings 220, and the DFG encodings 222. The cross similarity determinations between the AST encodings, the CFG encodings, and the DFG encodings are determined based, at least in part, on an inner dot product (“@” in FIG. 5) of an encoding matrix for each of the AST encodings 218, the CFG encodings 220, and the DFG encodings 222 with a transpose of the encoding matrix for each of the others of the AST encodings 218, the CFG encodings 220, and the DFG encodings 222. When the encodings are row normalized, this inner dot product may be equivalent to a cosine distance. For example, the self-supervised contrastive learning system 500 includes an A-C cross similarity 514 (similar to the AST to CFG self-supervised contrastive learning 400 of FIG. 4), a D-A cross similarity 516, and a C-D cross similarity 518. The A-C cross similarity 514 is the cross similarity between the AST encodings 218 and the CFG encodings 220 (AST @ CFG.T), which was discussed above with reference to FIG. 4. The D-A cross similarity 516 is the cross similarity between the DFG encodings 222 and the AST encodings 218 (DFG @ AST.T). The C-D cross similarity 518 is the cross-similarity between the CFG encodings 220 and the DFG encodings 222 (CFG @ DFG.T).

During training, the self-supervised contrastive learning system 500 outputs a contrastive loss value, train loss 522. This contrastive loss value indicates how well aligned the aligned embeddings are across the three graph types (AST, CFG, and DFG) for positive (matching) and negative (non-matching) pairs or triplets. In some embodiments, the contrastive loss value (train loss 522) may be determined based, at least in part, on mean cross similarities 520 between the AST encodings 218, the CFG encodings 220, and the DFG encodings 222 (e.g., A-C cross similarity 514+D-A cross similarity 516+C-D cross similarity 518)/3). In some embodiments, the contrastive loss value (train loss 522) may be determined based, at least in part, on average mean self-similarities of the AST encodings 218, the CFG encodings 220, and the DFG encodings 222 (e.g., (AST self-similarity 508+CFG self-similarity 510+DFG self-similarity 512)/3). As a specific, non-limiting example the contrastive loss value (train loss 522) may be determined based, at least in part, on a cross validation on a cross-similarity matrix (e.g., mean cross similarities 520) and a target matrix (e.g., train targets 524). The self-supervised contrastive learning system 500 is configured to minimize the contrastive loss value (e.g., train targets 524).

By way of non-limiting example, the output (e.g., set of aligned embeddings 226 of FIG. 2) of self-supervised contrastive learning system 500 may include a set of task-ready embeddings that represent the shared structure across the AST 206, the CFG 208, and the DFG 210 (FIG. 2) in a consistent, aligned way, along with a contrastive loss score (e.g., train loss 522) to quantify the alignment quality during training.

A zero-shot inference may be taken in some embodiments. For the sake of simplicity, this may be illustrated with an example taken with just two graph types (AST and CFG), but the example extends to all three graph types. For example, either an AST encoder 212 or a CFG encoder 214 from a trained model may be used to encode an AST and/or a CFG that are desired to be matched. Opposite encodings for all search candidates may be obtained. If AST is used, CFG encodings may be obtained. If CFG is used, AST encodings may be obtained. Pairwise distances of all search encodings may be obtained. The closest distance is the best match. This may be performed in both directions for stronger results (e.g., AST→CFG and CFG→AST).

Using embodiments disclosed herein, analysis of binary code may be performed much faster than that for conventional methods. For example, where days or weeks would have been needed to fully analyze binary code of a code base, an analysis according to embodiments disclosed herein may be completed in hours.

FIG. 6 is a flowchart illustrating a method 600 of automatically analyzing binary code, according to some embodiments. The method 600 illustrates an example of how multi-faceted/multi-channel contrastive learning leverages encoded information to represent the algorithmic structure of the binary code. At operation 602, the method 600 includes processing the binary code to generate a first mathematical representation of the binary code, a second mathematical representation of the binary code, and a third mathematical representation of the binary code representing an algorithmic structure of the binary code.

In some embodiments, the first mathematical representation includes an abstract syntax tree (AST) representing the algorithmic structure of the binary code, the second mathematical representation includes a control flow graph (CFG) representing the algorithmic structure of the binary code, and the third mathematical representation includes a data flow graph (DFG) representing the algorithmic structure of the binary code. In some embodiments, the first mathematical representation, the second mathematical representation, and the third mathematical representation include any three of an AST, a CFG, a DFG, a program dependence graph (PDG), a system dependence graph (SDG), a call graph, a control dependence graph, a value flow graph, a static single assignment (SSA) form, an abstract interpretation lattice, a petri net, a control/data flow matrix, and a hypergraph.

At operation 604, the method 600 includes encoding the first mathematical representation, the second mathematical representation, and the third mathematical representation to obtain first encodings corresponding to the first mathematical representation, second encodings corresponding to the second mathematical representation, and third encodings corresponding to the third mathematical representation. In some embodiments, the first mathematical representation, the second mathematical representation, and the third mathematical representation are encoded using graph convolutional neural networks to obtain the first encodings, the second encodings, and the third encodings. In some embodiments, each one of the first mathematical representation, the second mathematical representation, and the third mathematical representation is encoded using a different one of the following encoding techniques: graph convolutional neural networks, graph-centric neural models (e.g., other than graph convolutional neural networks), graph kernels and non-neural graph embeddings, sequence-centric models (e.g., bytes, opcodes, IR tokens, execution traces), tree-centric models (e.g., AST-like or decompiled pseudo-AST), constraint-based and logic-based encodings (e.g., symbolic/SMT), probabilistic and stochastic process models, code property graphs (CPG) and multi-view integration, representation learning and metric learning, matrix and tensor encodings, dynamic and concurrency models, neuro-symbolic hybrids, or program algebra and semantics-based embeddings.

At operation 606, the method 600 includes performing self-supervised contrastive learning on the first encodings, the second encodings, and the third encodings to generate a set of aligned embeddings representing the algorithmic structure of the binary code across the first mathematical representation, the second mathematical representation, and the third mathematical representation.

In some embodiments, processing the binary code (e.g., at operation 602) includes processing the binary code to generate a fourth mathematical representation of the binary code. In some embodiments, encoding the first, second, and third mathematical representations (e.g., at operation 604) further includes encoding the fourth mathematical representation to obtain fourth encodings corresponding to the fourth mathematical representation. The self-supervised contrastive learning (e.g., at operation 606) may be performed on the fourth encodings in addition to the first encodings, the second encodings, and the third encodings. The set of aligned embeddings represents the algorithmic structure of the binary code across the first mathematical representation, the second mathematical representation, the third mathematical representation, and the fourth mathematical representation. In some embodiments, the first, second, third, and fourth mathematical representations include any four of an AST, a CFG, a DFG, a PDG, an SDG, a call graph, a control dependence graph, a value flow graph, an SSA form, an abstract interpretation lattice, a petri net, a control/data flow matrix, and a hypergraph.

In some embodiments, processing the binary code (e.g., at operation 602) includes processing the binary code to generate a fifth mathematical representation of the binary code. In some embodiments, encoding the first, second, third, and fourth mathematical representations (e.g., at operation 604) further includes encoding the fifth mathematical representation to obtain fifth encodings corresponding to the fifth mathematical representation. The self-supervised contrastive learning may be performed on the fifth encodings in addition to the first encodings, the second encodings, the third encodings, and the fourth encodings. The set of aligned embeddings represents the algorithmic structure of the binary code across the first mathematical representation, the second mathematical representation, the third mathematical representation, the fourth mathematical representation, and the fifth mathematical representation. In some embodiments, the first, second, third, fourth, and fifth mathematical representations include any five of an AST, a CFG, a DFG, a PDG, an SDG, a call graph, a control dependence graph, a value flow graph, an SSA form, an abstract interpretation lattice, a petri net, a control/data flow matrix, and a hypergraph.

In some embodiments, the mathematical representations of the binary code may be encoded (e.g., at operation 604) using methods other than graph convolutional neural networks to obtain the encodings. By way of non-limiting example, the mathematical representations of the binary code (e.g., the first, second, third, fourth, and/or fifth mathematical representations) may be encoded using graph-centric neural models (e.g., other than graph convolutional neural networks), graph kernels and non-neural graph embeddings, sequence-centric models (e.g., bytes, opcodes, IR tokens, execution traces), tree-centric models (e.g., AST-like or decompiled pseudo-AST), constraint- and logic-based encodings (e.g., symbolic/SMT), probabilistic and stochastic process models, code property graphs (CPG) and multi-view integration, representation learning and metric learning, matrix and tensor encodings, dynamic and concurrency models, neuro-symbolic hybrids, or program algebra and semantics-based embeddings.

It will be appreciated by those of ordinary skill in the art that functional elements of embodiments disclosed herein (e.g., functions, operations, acts, processes, and/or methods) may be implemented in any suitable hardware, software, firmware, or combinations thereof. FIG. 7 illustrates non-limiting examples of implementations of functional elements disclosed herein. In some embodiments, some or all portions of the functional elements disclosed herein may be performed by hardware specially configured for carrying out the functional elements.

FIG. 7 is a block diagram of circuitry 700 that, in some embodiments, may be used to implement various functions, operations, acts, processes, and/or methods disclosed herein. The circuitry 700 includes one or more processors 702 (sometimes referred to herein as “processors 702”) operably coupled to one or more data storage devices (sometimes referred to herein as “storage 704”). The storage 704 includes machine-executable code 706 stored thereon and the processors 702 include logic circuitry 708. The machine-executable code 706 includes information describing functional elements that may be implemented by (e.g., performed by) the logic circuitry 708. The logic circuitry 708 is adapted to implement (e.g., perform) the functional elements described by the machine-executable code 706. The circuitry 700, when executing the functional elements described by the machine-executable code 706, should be considered as special purpose hardware configured for carrying out functional elements disclosed herein. In some embodiments the processors 702 may be configured to perform the functional elements described by the machine-executable code 706 sequentially, concurrently (e.g., on one or more different hardware platforms), or in one or more parallel process streams.

When implemented by logic circuitry 708 of the processors 702, the machine-executable code 706 is configured to adapt the processors 702 to perform operations of embodiments disclosed herein. For example, the machine-executable code 706 may be configured to adapt the processors 702 to perform at least a portion or a totality of the method 100 of FIG. 1 and/or the method 600 of FIG. 6. As another example, the machine-executable code 706 may be configured to adapt the processors 702 to perform at least a portion or a totality of the operations discussed for the decompiler 204, the AST encoder 212, and/or the self-supervised contrastive learning 224 of FIG. 2; a graph convolution neural network; the AST to CFG self-supervised contrastive learning 400 of FIG. 4; and/or the self-supervised contrastive learning system 500 of FIG. 5. As a specific, non-limiting example, the machine-executable code 706 may be configured to adapt the processors 702 to: process binary code to generate an abstract syntax tree (AST), a control flow graph (CFG), and a data flow graph (DFG) representing an algorithmic structure of the binary code; encode the AST, the CFG, and the DFG using graph convolutional neural networks to obtain AST encodings, CFG encodings, and DFG encodings; and perform self-supervised contrastive learning on the AST encodings, the CFG encodings, and the DFG encodings to generate a set of aligned embeddings representing the algorithmic structure of the binary code across the AST, the CFG, and the DFG.

The processors 702 may include a general purpose processor, a special purpose processor, a central processing unit (CPU), a dedicated or integrated graphics processing unit (GPU) (e.g., including cores dedicated to accelerating machine learning), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer is configured to execute functional elements corresponding to the machine-executable code 706 (e.g., software code, firmware code, hardware descriptions) related to embodiments of the present disclosure. It is noted that a general-purpose processor (may also be referred to herein as a host processor or simply a host) may be a microprocessor, but in the alternative, the processors 702 may include any conventional processor, controller, microcontroller, or state machine. The processors 702 may also be implemented as a combination of computing devices, such as a combination of a DSP and a microprocessor, a plurality of microprocessors, one or more microprocessors in conjunction with a DSP core, or any other such configuration.

In some embodiments the storage 704 includes volatile data storage (e.g., random-access memory (RAM)), non-volatile data storage (e.g., Flash memory, a hard disc drive, a solid state drive, erasable programmable read-only memory (EPROM), etc.). In some embodiments the processors 702 and the storage 704 may be implemented into a single device (e.g., a semiconductor device product, a system on chip (SOC), etc.). In some embodiments, internal software in devices may either operate within secure, isolated environments (e.g., trusted computing) or be managed by a lightweight, minimal kernel design (e.g., a microkernel) to increase robustness and/or security. In some embodiments the processors 702 and the storage 704 may be implemented into separate devices.

In some embodiments the machine-executable code 706 may include computer-readable instructions (e.g., software code, firmware code). By way of non-limiting example, the computer-readable instructions may be stored by the storage 704, accessed directly by the processors 702, and executed by the processors 702 using at least the logic circuitry 708. Also by way of non-limiting example, the computer-readable instructions may be stored on the storage 704, transferred to a memory device (not shown) for execution, and executed by the processors 702 using at least the logic circuitry 708. Accordingly, in some embodiments the logic circuitry 708 includes electrically configurable logic circuitry 708.

In some embodiments the machine-executable code 706 may describe hardware (e.g., circuitry) to be implemented in the logic circuitry 708 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, VERILOG™, SYSTEMVERILOG™ or very large-scale integration (VLSI) hardware description language (VHDL™) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of the logic circuitry 708 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some embodiments the machine-executable code 706 may include an HDL, an RTL, a GL description, a mask level description, other hardware description, or any combination thereof.

In embodiments where the machine-executable code 706 includes a hardware description (at any level of abstraction), a system (not shown, but including the storage 704) may be configured to implement the hardware description described by the machine-executable code 706. By way of non-limiting example, the processors 702 may include a programmable logic device (e.g., an FPGA or a PLC) and the logic circuitry 708 may be electrically controlled to implement circuitry corresponding to the hardware description into the logic circuitry 708. Also by way of non-limiting example, the logic circuitry 708 may include hard-wired logic manufactured by a manufacturing system (not shown, but including the storage 704) according to the hardware description of the machine-executable code 706.

Regardless of whether the machine-executable code 706 includes computer-readable instructions or a hardware description, the logic circuitry 708 is adapted to perform the functional elements described by the machine-executable code 706 when implementing the functional elements of the machine-executable code 706. It is noted that although a hardware description may not directly describe functional elements, a hardware description indirectly describes functional elements that the hardware elements described by the hardware description are capable of performing.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different sub-combinations of some of the elements. For example, the phrase “A, B, C, D, or combinations thereof” may refer to any one of A, B, C, or D; the combination of each of A, B, C, and D; and any sub-combination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

While the present disclosure has been described herein with respect to certain illustrated embodiments, those of ordinary skill in the art will recognize and appreciate that the present invention is not so limited. Rather, many additions, deletions, and modifications to the illustrated and described embodiments may be made without departing from the scope of the invention as hereinafter claimed along with their legal equivalents. In addition, features from one embodiment may be combined with features of another embodiment while still being encompassed within the scope of the invention as contemplated by the inventor.

What is claimed is:

1. A computing system, comprising:
one or more processors; and
one or more data storage devices having computer-readable instructions stored thereon, the computer-readable instructions configured to instruct the one or more processors to:
process binary code to generate an abstract syntax tree (AST), a control flow graph (CFG), and a data flow graph (DFG) representing an algorithmic structure of the binary code;
encode the AST, the CFG, and the DFG using graph convolutional neural networks to obtain AST encodings, CFG encodings, and DFG encodings; and
perform self-supervised contrastive learning on the AST encodings, the CFG encodings, and the DFG encodings to generate a set of aligned embeddings representing the algorithmic structure of the binary code across the AST, the CFG, and the DFG.

2. The computing system of claim 1, wherein the self-supervised contrastive learning includes:
a self-similarity determination for the AST encodings, the CFG encodings, and the DFG encodings; and
cross similarity determinations between the AST encodings, the CFG encodings, and the DFG encodings.

3. The computing system of claim 2, wherein the self-similarity determination for the AST encodings, the CFG encodings, and the DFG encodings is determined to be an inner dot product of an encoding matrix and a transpose of the encoding matrix for each of the AST encodings, the CFG encodings, and the DFG encodings.

4. The computing system of claim 2, wherein the cross similarity determinations between the AST encodings, the CFG encodings, and the DFG encodings are determined based, at least in part, on a dot product of an encoding matrix for each of the AST encodings, the CFG encodings, and the DFG encodings with a transpose of the encoding matrix for each of the others of the AST encodings, the CFG encodings, and the DFG encodings.

5. The computing system of claim 1, wherein the self-supervised contrastive learning is configured to generate a contrastive loss value indicating a degree of alignment of the aligned embeddings.

6. The computing system of claim 5, wherein the contrastive loss value is determined based, at least in part, on mean cross similarities between the AST encodings, the CFG encodings, and the DFG encodings.

7. The computing system of claim 5, wherein the contrastive loss value is determined based, at least in part, on average mean self-similarities of the AST encodings, the CFG encodings, and the DFG encodings.

8. The computing system of claim 5, wherein the self-supervised contrastive learning is configured to minimize the contrastive loss value.

9. The computing system of claim 1, wherein the AST encodings, the CFG encodings, and the DFG encodings are row normalized.

10. A method of automatically analyzing binary code, the method comprising:
processing binary code to generate an abstract syntax tree (AST), a control flow graph (CFG), and a data flow graph (DFG) representing an algorithmic structure of the binary code;
encoding the AST, the CFG, and the DFG using graph convolutional neural networks to obtain a AST encodings, CFG encodings, and DFG encodings; and
performing self-supervised contrastive learning on the AST encodings, the CFG encodings, and the DFG encodings to generate a set of aligned embeddings representing the algorithmic structure of the binary code across the AST, the CFG, and the DFG.

11. The method of claim 10, wherein the binary code comprises artificial intelligence generated binary code.

12. The method of claim 10, wherein processing the binary code comprises processing a malware binary code.

13. The method of claim 10, further comprising classifying the binary code based, at least in part, on the set of aligned embeddings.

14. The method of claim 10, wherein an alignment of the set of aligned embeddings includes more than three embeddings and is applicable to further collections of machine learning models, wherein a multi-faceted/multi-channel contrastive learning algorithm leverages encoded information to represent the algorithmic structure of the binary code.

15. One or more non-transitory computer-readable media having computer-readable instructions stored thereon, the computer-readable instructions configured to instruct the one or more processors to:
process binary code to generate a first mathematical representation of the binary code, a second mathematical representation of the binary code, and a third mathematical representation of the binary code representing an algorithmic structure of the binary code;
encode the first mathematical representation, the second mathematical representation, and the third mathematical representation to obtain first encodings corresponding to the first mathematical representation, second encodings corresponding to the second mathematical representation, and third encodings corresponding to the third mathematical representation; and
perform self-supervised contrastive learning on the first encodings, the second encodings, and the third encodings to generate a set of aligned embeddings representing the algorithmic structure of the binary code across the first mathematical representation, the second mathematical representation, and the third mathematical representation.

16. The one or more non-transitory computer-readable media of claim 15, wherein:
the first mathematical representation includes an abstract syntax tree (AST) representing the algorithmic structure of the binary code;
the second mathematical representation includes a control flow graph (CFG) representing the algorithmic structure of the binary code; and
the third mathematical representation includes a data flow graph (DFG) representing the algorithmic structure of the binary code.

17. The one or more non-transitory computer-readable media of claim 15, wherein the computer-readable instructions are configured to instruct the one or more processors to:
process the binary code to generate a fourth mathematical representation of the binary code; and
encode the fourth mathematical representation to obtain fourth encodings corresponding to the fourth mathematical representation;
wherein:
the self-supervised contrastive learning is performed on the fourth encodings in addition to the first encodings, the second encodings, and the third encodings;
the set of aligned embeddings represents the algorithmic structure of the binary code across the first mathematical representation, the second mathematical representation, the third mathematical representation, and the fourth mathematical representation.

18. The one or more non-transitory computer-readable media of claim 17, wherein the computer-readable instructions are configured to instruct the one or more processors to:
process the binary code to generate a fifth mathematical representation of the binary code; and
encode the fifth mathematical representation to obtain fifth encodings corresponding to the fifth mathematical representation;
wherein:
the self-supervised contrastive learning is performed on the fifth encodings in addition to the first encodings, the second encodings, the third encodings, and the fourth encodings;
the set of aligned embeddings represents the algorithmic structure of the binary code across the first mathematical representation, the second mathematical representation, the third mathematical representation, the fourth mathematical representation, and the fifth mathematical representation.

19. The one or more non-transitory computer-readable media of claim 15, wherein the first mathematical representation, the second mathematical representation, and the third mathematical representation are encoded using graph convolutional neural networks to obtain the first encodings, the second encodings, and the third encodings.

20. The one or more non-transitory computer-readable media of claim 15, wherein the first mathematical representation, the second mathematical representation, and the third mathematical representation include any three of an abstract syntax tree (AST), a control flow graph (CFG), a data flow graph (DFG), a program dependence graph (PDG), a system dependence graph (SDG), a call graph, a control dependence graph, a value flow graph, a static single assignment (SSA) form, an abstract interpretation lattice, a petri net, a control/data flow matrix, and a hypergraph.
